(19) United States
(12) Patent Application Publication
(10) Pub. No.: US 2025/0308400 A1
(43) Pub. Date: Oct. 2, 2025

(54) AUTOMATED GUIDANCE GENERATION BASED ON SITUATIONAL ANALYSIS

(71) Applicant: International Business Machines Corporation, Armonk, NY (US)

(72) Inventors: Zachary A. Silverstein, Georgetown, TX (US); Logan Bailey, Atlanta, GA (US); Jeremy R. Fox, Georgetown, TX (US); Fang Lu, Billerica, MA (US)

(21) Appl. No.: 18/616,680

(22) Filed: Mar. 26, 2024

(51) Int. Cl. G09B 5/06; G06F 1/16; G06F 11/34

(52) U.S. Cl. CPC G09B 5/06; G06F 1/163; G06F 11/3438

(57) ABSTRACT

Provided is a method, system, and computer program product for generating automated guidance based on situational analysis. A processor may receive a set of actions that a user requires assistance performing. The processor may identify IoT devices associated with the user. The processor may analyze real-time data from the IoT devices to determine a contextual surrounding of the user. The processor may determine that a first contextual surrounding matches a first action of the set of actions that the user requires assistance performing. The processor may determine, based on analyzing a current state of the user from the real-time data, if the user is in an optimal state to receive guidance. The processor may generate, in response to the user being in the optimal state, guidance for assisting the user to perform the first action. The processor may provide the guidance to the user via the IoT devices.

### BACKGROUND

The present disclosure relates generally to virtual and/or augmented reality, particularly focusing on the implementation of automated guidance/education techniques based on a situational analysis of a user's surroundings. These techniques aim to introduce opportunities for implicit learning and identification where users can engage with the guided and/or educational content in a highly immersive and interactive manner.

Virtual reality (VR) and augmented reality (AR) have emerged as groundbreaking technologies that blur the lines between the physical and virtual worlds. VR immerses users in entirely simulated environments, while AR overlays digital elements onto the real world. These technologies have rapidly evolved, offering immersive experiences that were once the realm of science fiction.

### SUMMARY

Embodiments of the present disclosure include a method, system, and computer program product for generating automated guidance for a user based on situational analysis. A processor may receive a set of actions that a user requires assistance performing. The processor may identify one or more Internet of Things (IoT) devices associated with the user. The processor may analyze real-time data from the one or more IoT devices to determine a contextual surrounding of the user. The processor may determine, in response to the analyzing, that a first contextual surrounding matches a first action of the set of actions that the user requires assistance performing. The processor may determine, based on analyzing a current state of the user from the real-time data, if the user is in an optimal state to receive guidance when performing the first action. The processor may generate, in response to the user being in the optimal state, guidance for assisting the user to perform the first action. The processor may provide the guidance to the user via the one or more IoT devices.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 illustrates a block diagram of an example automated situational analysis system, in accordance with embodiments of the present disclosure.

FIG. 2 illustrates a flow diagram for generating automated guidance for a user based on situational analysis, in accordance with some embodiments of the present disclosure.

FIG. 3 illustrates a process for generating automated guidance for a user based on situational analysis, in accordance with some embodiments of the present disclosure.

FIG. 4 illustrates a high-level block diagram of an example computer system that may be used in implementing one or more of the methods, tools, and modules, and any related functions, described herein, in accordance with embodiments of the present disclosure.

FIG. 5 depicts a schematic diagram of a computing environment for executing program code related to the methods disclosed herein and for generating automated guidance for a user based on situational analysis according to at least one embodiment.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate to VR and AR devices/systems and, more particularly, to automated guidance generation based on situational analysis of a user's surroundings within the virtual/augmented reality space. The present disclosure aims to introduce opportunities for implicit learning and identification where users can engage with the guided and/or educational content in a highly immersive and interactive manner. While the present disclosure is not necessarily limited to such applications, various aspects of the disclosure may be appreciated through a discussion of various examples using this context.

One of the key challenges addressed by VR and AR technologies is leveraging the user's current physical or virtual context to introduce opportunities for implicit learning and identification. The present disclosure uses VR and AR technologies to provide a platform where users can engage with educational content in a highly immersive and interactive manner. For example, the present disclosure may utilize VR simulations to replicate real-world scenarios where users can practice identifying spatial relationships, such as estimating distances or understanding relative sizes. In another example, the present disclosure may use AR, on the to overlay digital information onto the user's real-world environment, offering opportunities to implicitly learn through contextual cues and interactive elements.

By integrating guided and/or educational content into VR and AR experiences, developers and educators can harness the power of these technologies to create engaging and effective learning environments. Users can learn and practice implicit identifications in a way that feels natural and intuitive, leveraging their existing cognitive abilities to enhance the learning process. In this way, the present disclosure uses VR and AR technologies to provide innovative solutions for utilizing the user's physical or virtual context to facilitate learning and improve the retention of implicit identifications, contributing to a more immersive and effective educational experience.

Embodiments of this disclosure provide a computer-implemented method, computer program product, and situational analysis system for automated guidance and/or education generation to leverage situational analysis within the VR/AR space. In embodiments, the situational analysis system may receive a set of actions that a user requires assistance performing. For example, the user may select or provide a list of pre-defined actions (e.g., implicit interactions or educational assistance requests) that the user seeks help in performing or completing. The actions may be tailored to the user's desired actions or educational needs when performing one or more specific actions/tasks while wearing or using an IoT device. For example, the list of actions may consist of implicit actions and/or educational needs that the user relatively feels, such as actions like gauging distances, determining relative object sizes, assessing speeds, and understanding object structures (e.g., tracing cables within a network of cables).

In embodiments, the situational analysis system may identify one or more IoT devices associated with the user. For example, the system may identify and/or connect to one or more user provided IoT devices. These devices may include AR devices such as wearable augmented reality glasses or an AR enabled smartphone, VR devices such as a wearable VR headset, and/or a wearable smart device such as a smartwatch or band. The situational analysis system connects to the given IoT device(s) to collect or receive real-time data associated with the user and/or the user's contextual surrounding.

In embodiments, the situational analysis system may analyze the real-time data from the one or more IoT devices to determine a contextual surrounding of the user. The real-time data may be any type of data that can be analyzed to determine the contextual surrounding of the user, such as image data, audio data, textual data, meta data, and the like. The contextual surrounding (e.g., space or environment around the user) may be analyzed to determine if the it is optimal for assistance (e.g., is there a viable action or education opportunity the user needs assistance performing based on the data, is the user moving fast or slow, does the surround match the user's guidance preference, etc.). For example, the system may connect to AR glasses while the user is walking down a street and begin collecting real-time image data generated by an associated forward-facing camera of the AR glasses. The situational analysis system may analyze the real-time image data to determine that various objects are passing by or near the user at differing speeds (e.g., passing vehicles, people, objects, etc.). In embodiments, the situational analysis system may use machine learning or recognition algorithms (e.g., image recognition, pattern recognition, anomaly detection, feature recognition, text recognition, sound recognition, signal recognition and the like) to analyze the real-time data to make determination and/or predictions on the contextual surrounding of the user.

In embodiments, the situational analysis system may determine, in response to the analyzing, that a first contextual surrounding matches a first action of the set of actions that the user requires assistance performing. For example, using image recognition to analyze the real-time data, the system may identify that objects within the real-time data meet one or more action type thresholds (e.g., objects moving at a speed, recognition of a type of object, etc.), and determine that the given action is recognized within the contextual situation or surrounding.

Returning to the example above, the user may be curious about their neighborhood's speed limits, and list determining vehicle speeds as one of the predetermined actions the user needs help performing or assessing. The situational analysis system may identify from image data that a vehicle is driving through the neighborhood and, in turn, make predictions on the vehicle's speed since the user has requested assistance in determining speeds of vehicles within their neighborhood.

In embodiments, the situational analysis system may determine, based on analyzing a current state of the user from the real-time data, if the user is in an optimal state to receive guidance when performing the first action. Returning to the example above, the system may identify through a user-facing camera of the AR glasses and eye tracking algorithms if the user's attention is on the vehicle driving through the neighborhood. If the user is paying attention to the vehicle, then the user may be considered in the optimal state to receive guidance or educational content related to the moving vehicle. If not, then the system may continue to monitor and analyze the real-time data until the user is determined to be in the optimal state.

In embodiments, the situational analysis system may generate, in response to the user being in the optimal state, guidance for assisting the user to perform the first action. Returning to the example above, the situational analysis system may generate a predicted speed for the vehicle that is traveling through the user's neighborhood. This may be determined using various speed recognition algorithms (e.g., optical speed recognition, GPS-based speed recognition, doppler radar speed detection, machine learning speed recognition) that calculate the speed of various objects within the analyzed real-time image data.

In embodiments, the situational analysis system may provide the guidance to the user via the one or more IoT devices. The guidance may be provided to the user in a form that matches the given type of IoT device. For example, the guidance may be a virtual or augmented simulation that may be displayed to the user via a screen or display (e.g., VR/AR headset), audio content that is provided to the user via a speaker (e.g., smart speaker, phone speaker, watch speaker, etc.), and/or textual content that is presented to the user through a display. Returning to the example above, the situational analysis system may provide the speed of the vehicle via a textual representation overlayed on or near the vehicle within the user's AR headset. In some embodiments, the guidance may be provided to the user via gamification and/or a tutorial.

In this way, the system is configured to identify and generate guidance and/or educational opportunities equivalent to real-world scenarios, providing timely and tailored education where and when needed. It introduces a novel interaction paradigm centered around size, space, speed, and volumetric waypoints, offering a comprehensive and immersive educational experience within the VR/AR environment.

In some embodiments, the user(s) must opt into the situational analysis system for the system to collect, receive, analyze, generate, and/or use their information (e.g., collect real-time data associated with the user's IoT device(s), analyze user profile data, generate guidance, etc.). The user may determine which other users (e.g., third party user, second users, crowdsourced users, etc.) can access the collected, analyzed, and/or guidance data. For example, during an initialization process, the system may inform the user of the types of data that it will collect (e.g., image data, audio data, textual data, user feedback, guidance and/or educational content, etc.) and the reasons why the data is being collected. In these embodiments, the system will only start collecting the user information upon the user explicitly permitting the collection. Furthermore, the system may only collect the data that is necessary to generate the guidance for assisting the user when performing various actions. The data may be anonymized and/or encrypted while in use, and the data may only be maintained as needed for providing necessary actions. If the user chooses to opt out of the system, any user information previously collected may be permanently deleted.

While AR may be used as the primary example herein, this is not limiting on the implementation of the system. Embodiments of the present disclosure may be applied to virtual reality (VR), mixed reality (MR), augmented virtuality (AV), and other forms of real-and-virtual combined environments and human-machine actions generated by computer technology and wearables, as will be further described throughout the detailed description below.

The aforementioned advantages are example advantages, and not all advantages are discussed. Furthermore, embodiments of the present disclosure can exist that contain all, some, or none of the aforementioned advantages while remaining within the spirit and scope of the present disclosure.

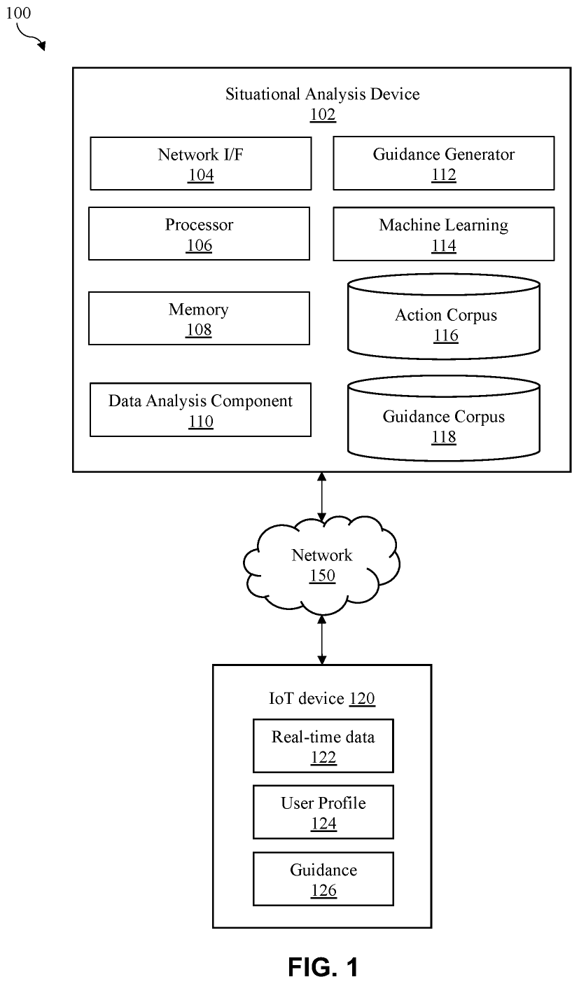

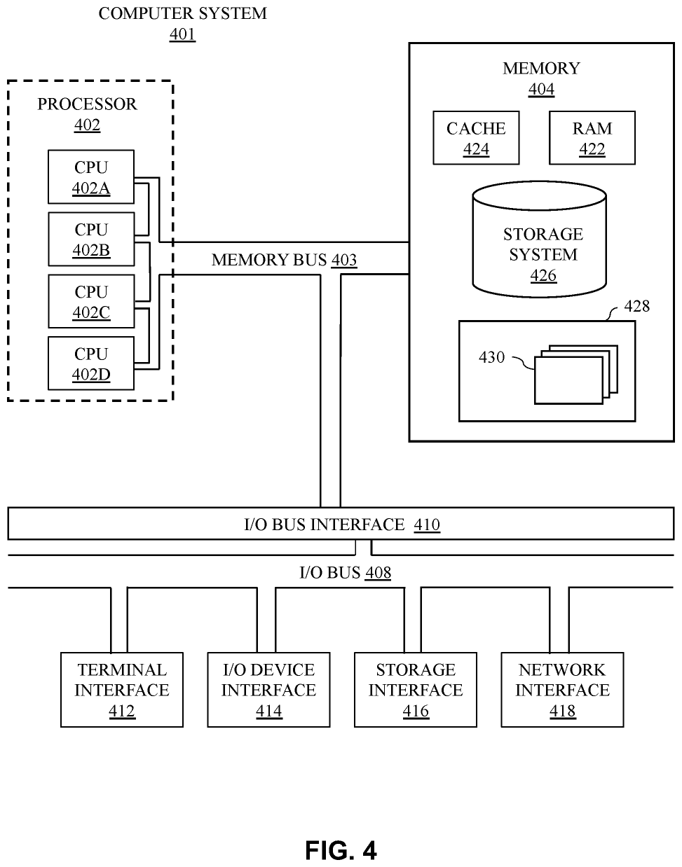

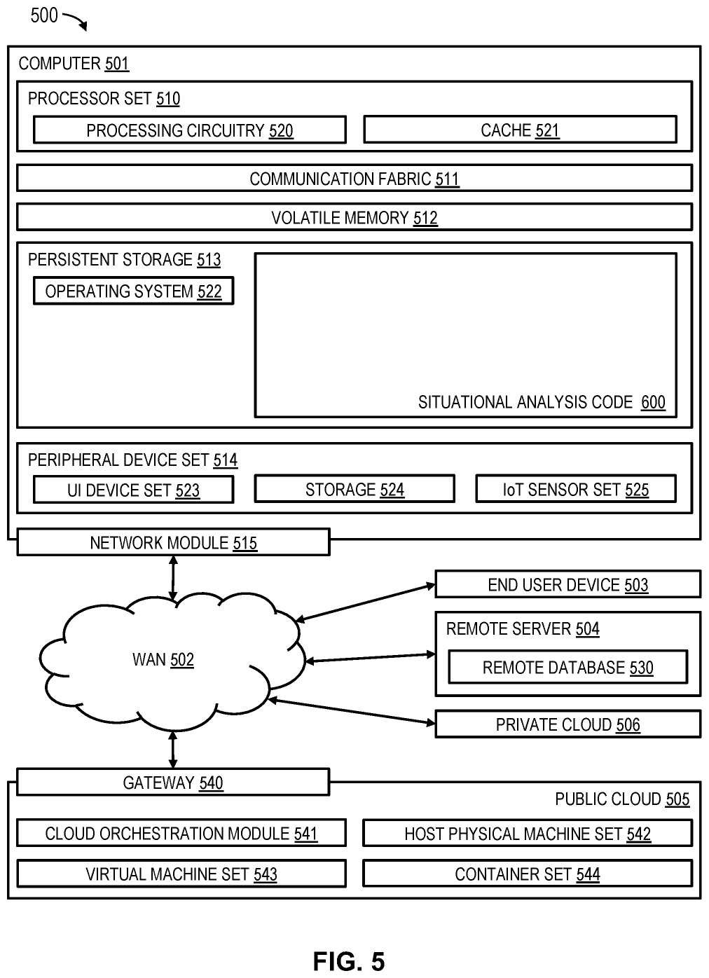

With reference now to FIG. 1, shown is a block diagram of an example situational analysis system 100, in accordance with embodiments of the present disclosure. In the illustrated embodiment, situational analysis system 100 includes situational analysis device 102 that is communicatively coupled to IoT device 120 via network 150. Situational analysis device 102 may be configured as any type of computer system and may be substantially similar to computer system 401 detailed in FIG. 4. IoT device 120 may be configured as any type of computer system include components similar to computer system 401 as described in FIG. 4. The situational analysis system 100 may be substantially similar to computer environment 500 as described in FIG. 5. In embodiments, IoT device 120 may be any type of computer system configured to generate real-time data that may be collected and analyzed by situational analysis device 102. For example, IoT device 120 may include AR devices (e.g., smart glasses, AR enabled smartphones and tablets), VR device (e.g., VR headsets, VR controllers), wearable devices (smartwatches, fitness trackers, smart clothing), IoT sensors (environmental sensor and cameras, location beacons), health devices (e.g., glucose monitors, blood pressure monitors, ECG monitors), and the like. IoT device 120 may include various components, processors, networks, etc., but for brevity, these components are not included in the figure. In some embodiments, the situational analysis device may include with the IoT device 120, such that the devices 100 and 120 are a single standalone device.

Network 150 may be any type of communication network, such as a wireless network or a cloud computing network. Network 150 may be substantially similar to, or the same as, a computing environment 500 described in FIG. 5. In some embodiments, network 150 can be implemented within a cloud computing environment or using one or more cloud computing services. Consistent with various embodiments, a cloud computing environment may include a network-based, distributed data processing system that provides one or more cloud computing services, where machine learning model algorithms, processes, and/or training may be executed. Further, a cloud computing environment may include many computers (e.g., hundreds or thousands of computers or more) disposed within one or more data centers and configured to share resources over network 150. In some embodiments, network 150 can be implemented using any number of any suitable communications media.

In the illustrated embodiment, IoT device 120 includes real-time data 122, user profile 124, and guidance 126. Real-time data 122 serves as the primary input collected from IoT device 120, where the real-time data is used by the situational analysis device 102 to learn patterns, determine contextual surroundings of the user, make predictions, or classify instances based on the relationships within the data.

In embodiments, user profile 124 may be configured to store information about the respective user such as preferences, selected or pre-determined actions that require assistance, educational requests, etc., that may be used by the situational analysis device 102 to tailor the generated guidance 126 to the specific user/user profile 124.

In embodiments, guidance 126 is received from situational analysis device 102 and provided to the user through components of the given type of IoT devices. For example, a VR headset or AR glasses (i.e., IoT device 120) may be configured to display a virtual simulation or overlay of the guidance generated by situational analysis device 102 to the user via one or more associated display systems. In another example, a smart speaker may be configured to provide or present the guidance generated from the situational analysis device 102 in an audio format to the user.

In the illustrated embodiment, situational analysis device 102 includes network interface (I/F) 104, processor 106, memory 108, data analysis component 110, guidance generator 112, machine learning component 114, action corpus 116, and guidance corpus 118.

In embodiments, data analysis component 110 is configured analyze real-time data 122 and a set of actions from user profile 124 that a user needs assistance in performing. The data analysis component 110 may utilize various machine learning algorithms 114 (e.g., image recognition, audio recognition, pattern recognitions, anomaly detection, feature recognition, signal recognition, text recognition and/or natural language processing) to analyze the real-time data 122 to identify the contextual surrounding of the user. Once the contextual surrounding of the user is determined from the analysis of the real-time data 122 with respect to the set of actions, the data analysis component 110 identifies actions (e.g., a first action, a second action, and so on) that the user needs assistance with performing from the contextual surrounding.

In embodiments, the guidance generator 112 is configured to harness the real-time data 122 from IoT device 120, leveraging this data to generate personalized guidance 126 or educational content tailored to the identified action the user requires assistance with. This sophisticated system 100 integrates seamlessly with a diverse array of IoT devices, including AR, VR, and wearable technologies, to capture comprehensive insights into the user's interactions, surroundings, and physiological metrics. For example, when a user initiates a request for assistance through a designated IoT device 120, such as an AR glasses or a smartwatch, the guidance generator 112 dynamically analyzes the real-time data 122 streaming from these devices, extracting key information relevant to the user's context and the specific action they aim to perform. The guidance generation process encompasses several layers of intelligent analysis. Firstly, the system interprets the user's current environment, considering factors like spatial dimensions, object interactions, and contextual cues. For example, if the user seeks guidance on assembling a complex structure, the system may utilize spatial tracking data from an AR glasses to visualize step-by-step instructions overlaid onto the real-world environment. Furthermore, the guidance generator 112 may collect additional user-specific data captured by wearable devices, such as heart rate, movement patterns, and biometric feedback. This personalized data adds another dimension to the guidance generation process, allowing the system to tailor recommendations based on the user's physical capabilities, cognitive load, and emotional state.

In embodiments, guidance generator 112 may utilized machine learning algorithms 112 to continuously refine and adapt the guidance based on iterative feedback loops. As the user interacts with the guidance 126, the system 100 gathers feedback data, analyzes user responses, and refines the guidance strategy to enhance effectiveness and user satisfaction. In embodiments, the generated guidance 126 or educational content is delivered to the user through intuitive interfaces on IoT devices. This may include visual instructions, audio prompts, haptic feedback, or interactive simulations, depending on the user's preferences and the nature of the task. The guidance 126 is designed to be immersive, engaging, and actionable, empowering users to navigate complex tasks with confidence and efficiency. Overall, the guidance generator 112 harnesses the power of IoT real-time data 122 to create a seamless and personalized learning experience, bridging the gap between user intent, contextual understanding, and actionable guidance in diverse scenarios.

In some embodiments, the guidance generator 112 may employ gamification strategies to deliver guidance tailored to the user's preferred learning style. This innovative approach utilizes VR/AR games presented to the user, guiding them through tasks related to the desired action. These games not only engage the user in an interactive learning experience but also track their performance scores across different aspects of the task. For instance, as the user engages with the VR/AR games, the guidance generator 112 monitors and records their scores related to various elements of the task. These elements could include speed, accuracy, problem-solving skills, and comprehension of educational content. By tracking these scores, the guidance generator 112 gains insights into the user's learning preferences and capabilities. Based on the highest scores achieved by the user and correlating them with their learning characteristics stored in the associated user profile, the guidance generator personalizes the gaming simulations. It modifies the gaming scenarios to align with the user's strengths, weaknesses, and preferred learning methods. This adaptive approach ensures that the user receives guidance and educational content in a format that optimally suits their individual learning style and needs.

Through gamification, the guidance generator 112 transforms the learning process into an engaging and dynamic journey, where users not only acquire knowledge and skills but also enjoy the learning experience. This gamified approach enhances user motivation, retention of information, and overall learning outcomes within the VR/AR environment.

In embodiments, action corpus 116 comprises a pre-defined set of implicit actions that the user(s) need assistance with performing. The implicit actions may include various actions related to the user's perception such as determining perceived distances from a first location to a second location, determining relative size of an object or environment, determining object speed relative to another waypoint, and/or structural determination.

In embodiments, guidance corpus 118 comprises historically generated guidance data and/or education content that has been generated to assist user's when performing various historical actions. In some embodiments, the historically generated guidance may be used by the situational analysis device to assist the user with the given identified action requiring assistance. In some embodiments, the situational analysis device 102 may utilize machine learning to analyze past/historic guidance to generate new guidance content to address new actions requiring assistance. In this way, the guidance corpus can continually grow and improve accuracy in assisting the user with various/new actions.

In embodiments, situational analysis device 102 may identify the most relevant action and ignore irrelevant or redundant actions from the contextual surrounding based on feature importance values or scores when compared to a predetermined action threshold. The situational analysis device 102 may use data analysis component 110 to analyze the features and determine a measure of importance of each feature. In some embodiments, the score may be generated based on how much information a feature contributes on its own to machine learning 114 and/or the given feature's contribution to the machine learning predictive power.

In some embodiments, data analysis component 110 may estimate the significance of each feature using a Random Forest algorithm. Random Forest is an ensemble learning method that constructs multiple decision trees and combines their predictions to make a final prediction. For regression tasks, the predictions from individual trees are averaged to obtain the final prediction. For classification tasks, the final prediction is made through a voting mechanism among the trees. Random Forests can provide insights into feature importance, helping to identify which features contribute most to the model's predictions. In this way, the situational analysis device may predict the given action that matches the user's list of actions based on feature importance.

In some embodiments, the situational analysis device 102 utilizes machine learning component 114 to conduct iterative experiments, generating additional training data. The machine learning component comprises various engines, such as artificial neural networks, correlation engines, reinforcement feedback learning models, and supervised/unsupervised learning models. These engines analyze real-time data types like image data, biometrics, performance metrics, and learning characteristics to produce contextually relevant guidance.

A machine learning model undergoes training with a specific algorithm, receiving inputs to make predictions, also known as predicted outputs or outputs. The model includes a representation or artifact comprising parameter values (theta values) used by the algorithm to generate predictions. Training involves determining these theta values, and their structure depends on the algorithm employed.

FIG. 1 is intended to depict the representative major components of automated situational analysis system 100. In some embodiments, however, individual components may have greater or lesser complexity than as represented in FIG. 1, components other than or in addition to those shown in FIG. 1 may be present, and the number, type, and configuration of such components may vary. Likewise, one or more components shown with automated situational analysis system 100 may not be present, and the arrangement of components may vary. For example, while FIG. 1 illustrates an example situational analysis system 100 having a single situational analysis device 102 and a single IoT device 120 that are communicatively coupled via a single network 150, suitable network architectures for implementing embodiments of this disclosure may include any number of situational analysis devices, IoT devices, and networks. The various models, modules, systems, and components illustrated in FIG. 1 may exist, if at all, across a plurality of situational analysis devices, IoT devices, and networks.

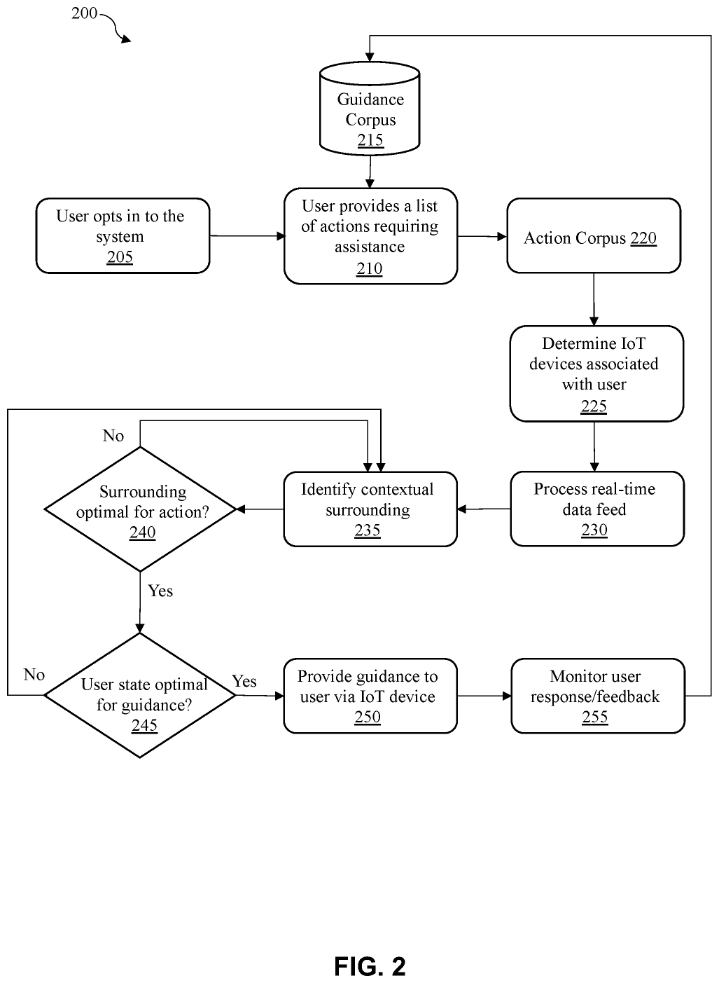

Referring now to FIG. 2, shown is an example flow diagram 200 for generating automated guidance for a user based on situational analysis, in accordance with some embodiments of the present disclosure. In the illustrated embodiment, the user initiates participation by opting in to the terms and conditions, signaling their interest and engagement with the situational analysis system 100. This is shown at step 205. In doing so, the user has the option to either provide or select from a collection of predefined corpuses containing implicit actions (or educational opportunities) that the user may need assistance or guidance in performing. This is shown at step 210.

In embodiments, the action corpus 220 may be customized in several ways. For example, the action corpus can be a subset derived from a larger corpus, tailored to the user's specific action/educational requirements, or determined based on known data feeds related to the user and their device. The action corpus 220 provides opportunities for implicit action or educational assistance identification based on the user's identified surrounding context. These opportunities encompass a range of experiences that are perceptible in a relative sense. For example, the implicit actions may involve gauging distance between locations, comparing relative sizes, assessing relative speeds, or tracing structural components to determine how they interact (e.g., cables for understanding connectivity).

In embodiments, the situational analysis 102 is configured to integrate with a variety of user-provided IoT devices 120. This is shown at step 205. These devices can include AR devices like wearable AR glasses or a phone camera, VR devices such as Oculus Rift, or other wearable VR gear, as well as IoT devices like smartwatches. Upon connection, the situational analysis system 100 begins processing the contextual real-time data gathered from the IoT devices in relation to the user's chosen action/educational assistance opportunities. This is shown at step 230. This data processing may involve utilizing various geographic mapping to perceive felt distances, analyzing camera feeds for observed distances, and/or interpreting speedometer data to understand perceived speeds.

In embodiments, the situational analysis device 102 evaluates the surrounding context of the user and their environment. This is shown at step 235. This assessment involves determining if the surroundings are conducive to effective learning experiences, considering factors such as the user's movement speed, the general environment, and potential sources of error (e.g., weather conditions) that could affect data accuracy.

Based on these analyses, the situational analysis device 102 determines whether the current context aligns with suitable educational events. This is shown at step 240. It also evaluates the user's state for optimal implicit action, taking into account factors like whether the user is driving or if their attention is diverted elsewhere. This is shown at step 245.

Using this information, the situational analysis device 102 generates personalized education opportunities or gamified activities to test the user's accuracy and learning progress. This is shown at step 250. The results of the user's responses and accuracy are then captured and integrated back into the overall corpus, informing future decisions regarding when and how to introduce educational content and the appropriate level of difficulty. This is shown at step 255.

For example, a user wearing an IoT smartwatch may be seated in a vehicle as a passenger. The smartwatch, connected to the vehicle's data system, detects the vehicle's speed and sends a prompt to the user's smartwatch display. The prompt notifies the user of the current speed, providing real-time feedback on their surroundings. This instant feedback helps the user stay informed about their environment and fosters awareness of their speed even when not actively driving. In another example and continuing with the smartwatch scenario, the user may receive another prompt indicating that the next block they are approaching is exactly 3 acres by 3 acres in size. This information is valuable for urban planning or real estate purposes, giving the user a spatial understanding of their surroundings. The prompt enhances the user's perception of their environment, making them more aware of spatial dimensions and land use.

In some embodiments, the situational analysis device 102 may generate guidance for a reverse viewing of an object from its perspective which involves a unique approach to actions within a specific time and space. For example, instead of the user directly manipulating or observing an object, they are empowered to choose any object or context within a given environment. This selection sets a waypoint in both time and space, creating a reference point for subsequent actions. In embodiments, the process begins with the user selecting an object or context of interest from the VR or AR space. This could range from a physical object in the real world to a virtual entity within a digital environment. The situational analysis device 102 then initiates a reverse viewing or experiencing mode, where the user is presented with the object's perspective or point of view.

In this mode, the user gains insights into how the chosen object perceives its surroundings. This could include visual representations, sensory data, or even simulated cognitive processes. For example, if the chosen object is a surveillance camera, the user may see the view captured by the camera and understand how it monitors its environment. As the user interacts with the object from its perspective, they can progressively gather information and insights. This experiential learning process allows users to build a nuanced understanding of the object's role, behavior, and actions within its environment. One key aspect of this approach is the ability to establish waypoints within time and space, effectively mapping out contextual information. These waypoints serve as reference points that users can utilize to formulate contextual questions or queries for natural language processing (NLP)-based conversations. For instance, if a user chooses a historical monument as the object of interest, they can experience the monument's perspective across different time periods. This experience can help them develop contextual questions related to the monument's historical significance, architectural evolution, or cultural impact.

Overall, the reverse viewing or experiencing of objects empowers users to gain a deeper understanding of entities within their environment. By leveraging this perspective-based action, users can enhance their cognitive mapping abilities, refine their inquiries through contextual waypoints, and engage in more meaningful NLP-driven conversations.

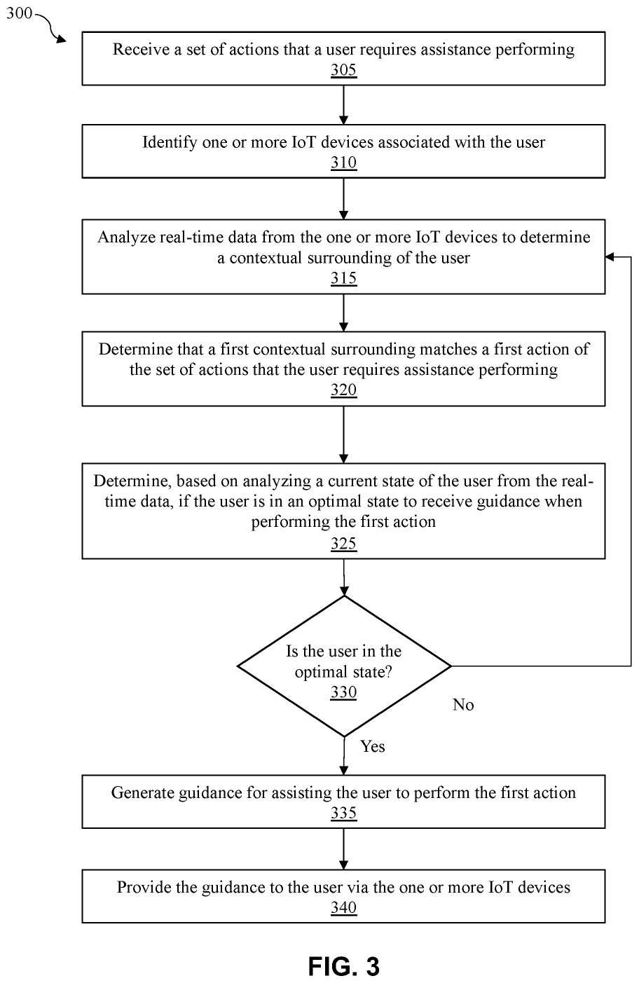

Referring now to FIG. 3, shown is an example process 300 for generating automated guidance for a user based on situational analysis. The process 300 may be performed by processing logic that comprises hardware (e.g., circuitry, dedicated logic, programmable logic, microcode, etc.), software (e.g., instructions run on a processor), firmware, or a combination thereof. In some embodiments, the process 300 is a computer-implemented process. In embodiments, the process 300 may be performed by processor 106 of situational analysis device 102 exemplified in FIG. 1.

The process 300 begins by receiving a set of actions that a user requires assistance performing. This is illustrated at step 305. In some embodiments, the set of actions that a user requires assistance performing is chosen from a group of actions consisting of: a speed measurement of one or more objects within the contextual surrounding of the user; a speed measurement of the user with respect to one or more objects within the contextual surround of the user; a distance measurement between two or more objects within the contextual surrounding of the user; a geographic measurement of an area within the contextual surrounding of the user; an assessment of volumetric space for receiving one or more objects within the contextual surrounding of the user; and a mapping of one or more object within the contextual surrounding of the user. For example, the user may select that they need assistance in assessing various volumetric space information when driving a vehicle. For example, this may include a request for guidance or educational assistance when passing other vehicles on a highway or parking in various marked lines in a parking lot.

The process 300 continues by identifying one or more IoT devices associated with the user. This is illustrated at step 310. In embodiments, the one or more IoT devices may be at least one of an AR device, a VR device, or a wearable smart device, though this is not meant to be limiting. Returning the example above, the user may be utilizing AR glasses while operating their vehicle.

The process 300 continues by analyzing real-time data from the one or more Internet of Things (IoT) devices to determine a contextual surrounding of the user. This is illustrated at step 315. Returning to the example, the situational analysis device 102 may collect and analyze the real-time data from the AR glasses to determine that the user is driving on a highway in traffic or attempting to park their vehicle.

The process 300 continues by determining, in response to the analyzing, that a first contextual surrounding matches a first action of the set of actions that the user requires assistance performing. This is illustrated at step 320. Returning to the example, the situational analysis device 102 may determine from image recognition that the user is driving a vehicle while in traffic and/or a parking lot which matches one of the user's pre-defined actions requiring assistance when performing.

The process 300 continues by determining, based on analyzing a current state of the user from the real-time data, if the user is in an optimal state to receive guidance when performing the first action. This is illustrated at step 325. The situational analysis device 102 determines if the user is ready to receive the guidance based on their current state.

If the user is not in the optimal state, (“No” at step 330), then the process 300 continues by returning to step 315 where the situational analysis device 102 continues to analyze the real-time data until the user is in the optimal state. For example, the user may not be in the process of passing a vehicle or parking, and therefore, no guidance will be generated to assist the user.

If the user's state is in an optimal state (“Yes” at step 330), then the process 300 continues by generating, in response to the user being in the optimal state, guidance for assisting the user to perform the first action. This is shown at step 335. For example, the situational analysis device 102 may identify that the user has initiated a turn signal that indicates they plan to pass another vehicle or that the user has initiated parking the vehicle within a set of parking lanes based on collected real-time data from the AR glasses. Based on the contextual surrounding/situation (e.g., initiation of the signal or parking maneuvers), the user is determined to be in the optimal state to receive the guidance. At which point the situational analysis device 102 may generate guidance that will overlay virtual representations of objects' sizes relevant to the user's task at hand. For instance, if the user is trying to pass another vehicle within the contextual surround or park a vehicle, the situational analysis device 102 can automatically activate the feature and provide visual cues to the user showing how the vehicle fits between other vehicles driving on the highway or in between the marked parking lines.

In some embodiments, the guidance may be determined from a guidance corpus. The guidance corpus may be generated by machine learning. For example, this may include collecting historical user action data from a plurality of IoT devices; training, using the historical user action data, a machine learning model to identify a plurality of actions that a plurality of users require assistance performing; and generating, by the machine learning model and based on the training, a guidance corpus for assisting users when performing the plurality of actions.

The process 300 continues by providing the guidance to the user via the one or more IoT devices. The guidance may be provided to the user based on the type of IoT device associated with the user. For example, the guidance is provided to the user as a visual simulation on a display of the one or more IoT devices. For example, the visual simulation may be provided to a VR/AR headset display or a display on a wearable smart watch. The simulation may provide guidance for completing or assisting in a given action that the user has requested assistance in performing. This immersive experience aids the user in understanding spatial relationships and improves their ability to navigate and utilize physical spaces effectively.

In another example, the one or more IoT devices is at least one of a virtual reality device or an augmented reality device, and wherein providing the guidance to the user comprises displaying a gamified version of the guidance to the user. In another example, the guidance is provided to the user as audio content via a speaker of the one or more IoT devices.

In some embodiments, the process 300 may continue by monitoring the real-time data to determine if the user has successfully completed the first action according to the guidance; and in response to identifying that the user has successfully completed the first action according to the guidance, updating the guidance corpus with the generated guidance.

Referring now to FIG. 4, shown is a high-level block diagram of an example computer system 401 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 401 may comprise one or more CPUs 402, a memory subsystem 404, a terminal interface 412, a storage interface 416, an I/O (Input/Output) device interface 414, and a network interface 418, all of which may be communicatively coupled, directly or indirectly, for inter-component communication via a memory bus 403, an I/O bus 408, and an I/O bus interface 410.

The computer system 401 may contain one or more general-purpose programmable central processing units (CPUs) 402A, 402B, 402C, and 402D, herein generically referred to as the CPU 402. In some embodiments, the computer system 401 may contain multiple processors typical of a relatively large system; however, in other embodiments the computer system 401 may alternatively be a single CPU system. Each CPU 402 may execute instructions stored in the memory subsystem 404 and may include one or more levels of on-board cache. In some embodiments, a processor can include at least one or more of, a memory controller, and/or storage controller. In some embodiments, the CPU can execute the processes included herein (e.g., flow diagram 200 and process 300 as described in FIG. 2 and FIG. 3, respectively). In some embodiments, the computer system 401 may be configured as situation analysis system 100 of FIG. 1.

System memory subsystem 404 may include computer system readable media in the form of volatile memory, such as random-access memory (RAM) 422 or cache memory 424. Computer system 401 may further include other removable/non-removable, volatile/non-volatile computer system data storage media. By way of example only, storage system 426 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory subsystem 404 can include flash memory, e.g., a flash memory stick drive or a flash drive. Memory devices can be connected to memory bus 403 by one or more data media interfaces. The memory subsystem 404 may include at least one program product having a set (e.g., at least one) of program modules that are configured to carry out the functions of various embodiments.

Although the memory bus 403 is shown in FIG. 4 as a single bus structure providing a direct communication path among the CPUs 402, the memory subsystem 404, and the I/O bus interface 410, the memory bus 403 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 410 and the I/O bus 408 are shown as single units, the computer system 401 may, in some embodiments, contain multiple I/O bus interfaces 410, multiple I/O buses 408, or both. Further, while multiple I/O interface units are shown, which separate the I/O bus 408 from various communications paths running to the various I/O devices, in other embodiments some or all of the I/O devices may be connected directly to one or more system I/O buses.

In some embodiments, the computer system 401 may be a multi-user mainframe computer system, a single-user system, or a server computer or similar device that has little or no direct user interface but receives requests from other computer systems (clients). Further, in some embodiments, the computer system 401 may be implemented as a desktop computer, portable computer, laptop or notebook computer, tablet computer, pocket computer, telephone, smart phone, network switches or routers, or any other appropriate type of electronic device.

It is noted that FIG. 4 is intended to depict the representative major components of an exemplary computer system 401. In some embodiments, however, individual components may have greater or lesser complexity than as represented in FIG. 4, components other than or in addition to those shown in FIG. 4 may be present, and the number, type, and configuration of such components may vary.

One or more programs/utilities 428, each having at least one set of program modules 430 may be stored in memory subsystem 404. The programs/utilities 428 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs/utilities 428 and/or program modules 430 generally perform the functions or methodologies of various embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pitslands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

Embodiments of the present disclosure may be implemented together with virtually any type of computer, regardless of the platform is suitable for storing and/or executing program code. FIG. 5 shows, as an example, a computing environment 500 (e.g., cloud computing system) suitable for executing program code related to the methods disclosed herein and for situational analysis management. In some embodiments, the computing environment 500 may be the same as or an implementation of the computing environment of situational analysis system 100.

Computing environment 500 contains an example of an environment for the execution of at least some of the computer code involved in performing the inventive methods, such as situational analysis code 600. The situational analysis 600 may be a code-based implementation of the automated machine learning system 100. In addition to situational analysis 600, computing environment 500 includes, for example, a computer 501, a wide area network (WAN) 502, an end user device (EUD) 503, a remote server 504, a public cloud 505, and a private cloud 506. In this embodiment, the computer 501 includes a processor set 510 (including processing circuitry 520 and a cache 521), a communication fabric 511, a volatile memory 512, a persistent storage 513 (including operating a system 522 and the situational analysis 600, as identified above), a peripheral device set 514 (including a user interface (UI) device set 523, storage 524, and an Internet of Things (IoT) sensor set 525), and a network module 515. The remote server 504 includes a remote database 530. The public cloud 505 includes a gateway 540, a cloud orchestration module 541, a host physical machine set 542, a virtual machine set 543, and a container set 544.

The computer 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 530. As is well understood in the art of computer technology, and depending upon the technology, performance of a computer-implemented method may be distributed among multiple computers and/or between multiple locations. On the other hand, in this presentation of the computing environment 500, detailed discussion is focused on a single computer, specifically the computer 501, to keep the presentation as simple as possible. The computer 501 may be located in a cloud, even though it is not shown in a cloud in FIG. 5. On the other hand, the computer 501 is not required to be in a cloud except to any extent as may be affirmatively indicated.

The processor set 510 includes one, or more, computer processors of any type now known or to be developed in the future. The processing circuitry 520 may be distributed over multiple packages, for example, multiple, coordinated integrated circuit chips. The processing circuitry 520 may implement multiple processor threads and/or multiple processor cores. The cache 521 is memory that is located in the processor chip package(s) and is typically used for data or code that should be available for rapid access by the threads or cores running on the processor set 510. Cache memories are typically organized into multiple levels depending upon relative proximity to the processing circuitry. Alternatively, some, or all, of the cache for the processor set may be located “off chip.” In some computing environments, the processor set 510 may be designed for working with qubits and performing quantum computing.

Computer readable program instructions are typically loaded onto the computer 501 to cause a series of operational steps to be performed by the processor set 510 of the computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as the cache 521 and the other storage media discussed below. The program instructions, and associated data, are accessed by the processor set 510 to control and direct performance of the inventive methods. In the computing environment 500, at least some of the instructions for performing the inventive methods may be stored in the situational analysis 600 in the persistent storage 513.

The communication fabric 511 is the signal conduction path that allows the various components of the computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

The volatile memory 512 is any type of volatile memory now known or to be developed in the future. Examples include dynamic type random access memory (RAM) or static type RAM. Typically, the volatile memory 512 is characterized by random access, but this is not required unless affirmatively indicated. In the computer 501, the volatile memory 512 is located in a single package and is internal to the computer 501, but, alternatively or additionally, the volatile memory may be distributed over multiple packages and/or located externally with respect to the computer 501.

The persistent storage 513 is any form of non-volatile storage for computers that is now known or to be developed in the future. The non-volatility of this storage means that the stored data is maintained regardless of whether power is being supplied to the computer 501 and/or directly to the persistent storage 513. The persistent storage 513 may be a read only memory (ROM), but typically at least a portion of the persistent storage allows writing of data, deletion of data and re-writing of data. Some familiar forms of persistent storage include magnetic disks and solid-state storage devices. The operating system 522 may take several forms, such as various known proprietary operating systems or open-source Portable Operating System Interface-type operating systems that employ a kernel. The code included in the situational analysis 600 typically includes at least some of the computer code involved in performing the inventive methods.

The peripheral device set 514 includes the set of peripheral devices of the computer 501. Data communication connections between the peripheral devices and the other components of the computer 501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 523 may include components such as a display screen, speaker, microphone, wearable devices (such as goggles and smart watches), keyboard, mouse, printer, touchpad, game controllers, and haptic devices. The storage 524 is external storage, such as an external hard drive, or insertable storage, such as an SD card. The storage 524 may be persistent and/or volatile. In some embodiments, the storage 524 may take the form of a quantum computing storage device for storing data in the form of qubits. In embodiments where the computer 501 is required to have a large amount of storage (for example, where the computer 501 locally stores and manages a large database) then this storage may be provided by peripheral storage devices designed for storing very large amounts of data, such as a storage area network (SAN) that is shared by multiple, geographically distributed computers. The IoT sensor set 525 is made up of sensors that can be used in Internet of Things applications. For example, one sensor may be a thermometer and another sensor may be a motion detector.

The network module 515 is the collection of computer software, hardware, and firmware that allows the computer 501 to communicate with other computers through the WAN 502. The network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 515 are performed on the same physical hardware device. In other embodiments (for example, embodiments that utilize software-defined networking (SDN)), the control functions and the forwarding functions of the network module 515 are performed on physically separate devices, such that the control functions manage several different network hardware devices. Computer readable program instructions for performing the inventive methods can typically be downloaded to the computer 501 from an external computer or external storage device through a network adapter card or network interface included in the network module 515.

The WAN 502 is any wide area network (for example, the internet) capable of communicating computer data over non-local distances by any technology for communicating computer data, now known or to be developed in the future. In some embodiments, the WAN 502 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

The end user device (EUD) 503 is any computer system that is used and controlled by an end user (for example, a customer of an enterprise that operates the computer 501) and may take any of the forms discussed above in connection with the computer 501. The EUD 503 typically receives helpful and useful data from the operations of the computer 501. For example, in a hypothetical case where the computer 501 is designed to provide a recommendation to an end user, this recommendation would typically be communicated from the network module 515 of the computer 501 through the WAN 502 to the EUD 503. In this way, the EUD 503 can display, or otherwise present, the recommendation to an end user. In some embodiments, the EUD 503 may be a client device, such as thin client, heavy client, mainframe computer, desktop computer and so on.

The remote server 504 is any computer system that serves at least some data and/or functionality to the computer 501. The remote server 504 may be controlled and used by the same entity that operates computer 501. The remote server 504 represents the machine(s) that collect and store helpful and useful data for use by other computers, such as the computer 501. For example, in a hypothetical case where the computer 501 is designed and programmed to provide a recommendation based on historical data, then this historical data may be provided to the computer 501 from the remote database 530 of the remote server 504.

The public cloud 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of the public cloud 505 is performed by the computer hardware and/or software of the cloud orchestration module 541. The computing resources provided by the public cloud 505 are typically implemented by virtual computing environments that run on various computers making up the computers of the host physical machine set 542, which is the universe of physical computers in and/or available to the public cloud 505. The virtual computing environments (VCEs) typically take the form of virtual machines from the virtual machine set 543 and/or containers from the container set 544. It is understood that these VCEs may be stored as images and may be transferred among and between the various physical machine hosts, either as images or after instantiation of the VCE. The cloud orchestration module 541 manages the transfer and storage of images, deploys new instantiations of VCEs and manages active instantiations of VCE deployments. The gateway 540 is the collection of computer software, hardware, and firmware that allows the public cloud 505 to communicate through the WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 506 is similar to the public cloud 505, except that the computing resources are only available for use by a single enterprise. While the private cloud 506 is depicted as being in communication with the WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 505 and the private cloud 506 are both part of a larger hybrid cloud.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed. In some embodiments, one or more of the operating system 522 and the situational analysis 600 may be implemented as service models. The service models may include software as a service (SaaS), platform as a service (PaaS), and infrastructure as a service (IaaS). In SaaS, the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings. In PaaS, the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. In IaaS, the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatuses, or another device to cause a series of operational steps to be performed on the computer, other programmable apparatus or other device to produce a computer implemented process, such that the instructions which execute on the computer, other programmable apparatuses, or another device implement the functions/acts specified in the flowchart and/or block diagram block or blocks.

The flowcharts and/or block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or act or carry out combinations of special purpose hardware and computer instructions.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will further be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of the present disclosure has been presented for purposes of illustration and description but is not intended to be exhaustive or limited to the present disclosure in the form disclosed. Many modifications and variations will be apparent to those of ordinary skills in the art without departing from the scope of the present disclosure. The embodiments are chosen and described in order to explain the principles of the present disclosure and the practical application, and to enable others of ordinary skills in the art to understand the present disclosure for various embodiments with various modifications, as are suited to the particular use contemplated.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer-implemented method comprising:
receiving a set of actions that a user requires assistance performing;
identifying one or more Internet of Things (IoT) devices associated with the user;
analyzing real-time data from the one or more IoT devices to determine a contextual surrounding of the user;
determining, in response to the analyzing, that a first contextual surrounding matches a first action of the set of actions that the user requires assistance performing;
determining, based on analyzing a current state of the user from the real-time data, if the user is in an optimal state to receive guidance when performing the first action;
generating, in response to the user being in the optimal state, guidance for assisting the user to perform the first action; and
providing the guidance to the user via the one or more IoT devices.

2. The method of claim 1, wherein the one or more IoT devices is at least one of an augmented reality device, a virtual reality device, or a wearable smart device.

3. The method of claim 1, wherein the guidance is provided to the user as a visual simulation via a display on the one or more IoT devices.

4. The method of claim 1, wherein the one or more IoT devices is at least one of a virtual reality device or an augmented reality device, and wherein providing the guidance to the user comprises displaying a gamified version of the guidance to the user.

5. The method of claim 1, wherein the guidance is provided to the user as audio content via a speaker of the one or more IoT devices.

6. The method of claim 1, wherein the set of actions that a user requires assistance performing is chosen from a group of actions consisting of:
a speed measurement of one or more objects within the contextual surrounding of the user;
a speed measurement of the user with respect to one or more objects within the contextual surround of the user;
a distance measurement between two or more objects within the contextual surrounding of the user;
a geographic measurement of an area within the contextual surrounding of the user;
an assessment of volumetric space for receiving one or more objects within the contextual surrounding of the user; and
a mapping of one or more object within the contextual surrounding of the user.

7. The method of claim 1, further comprising:
collecting historical user action data from a plurality of IoT devices;
training, using the historical user action data, a machine learning model to identify a plurality of actions that a plurality of users require assistance performing; and
generating, by the machine learning model and based on the training, a guidance corpus for assisting users when performing the plurality of actions.

8. The method of claim 7, further comprising:
monitoring the real-time data to determine if the user has successfully completed the first action according to the guidance; and
in response to identifying that the user has successfully completed the first action according to the guidance, updating the guidance corpus with the generated guidance.

9. A system comprising:
a processor; and
a computer-readable storage medium communicatively coupled to the processor and storing program instructions which, when executed by the processor, cause the processor to perform a method comprising:
receiving a set of actions that a user requires assistance performing;
identifying one or more Internet of Things (IoT) devices associated with the user;
analyzing real-time data from the one or more IoT devices to determine a contextual surrounding of the user;
determining, in response to the analyzing, that a first contextual surrounding matches a first action of the set of actions that the user requires assistance performing;
determining, based on analyzing a current state of the user from the real-time data, if the user is in an optimal state to receive guidance when performing the first action;
generating, in response to the user being in the optimal state, guidance for assisting the user to perform the first action; and
providing the guidance to the user via the one or more IoT devices.

10. The system of claim 9, wherein the one or more IoT devices is at least one of an AR device, a VR device, or a wearable smart device.

11. The system of claim 9, wherein the guidance is provided to the user as a visual simulation via a display on the one or more IoT devices.

12. The system of claim 9, wherein the one or more IoT devices is at least one of a virtual reality device or an augmented reality device, and wherein providing the guidance to the user comprises displaying a gamified version of the guidance to the user.

13. The system of claim 9, wherein the set of actions that a user requires assistance performing is chosen from a group of actions consisting of:
a speed measurement of one or more objects within the contextual surrounding of the user;
a speed measurement of the user with respect to one or more objects within the contextual surround of the user;
a distance measurement between two or more objects within the contextual surrounding of the user;
a geographic measurement of an area within the contextual surrounding of the user;
an assessment of volumetric space for receiving one or more objects within the contextual surrounding of the user; and
a mapping of one or more object within the contextual surrounding of the user.

14. The system of claim 9, wherein the method performed by the processor further comprises:
collecting historical user action data from a plurality of IoT devices;
training, using the historical user action data, a machine learning model to identify a plurality of actions that a plurality of users require assistance performing; and
generating, by the machine learning model and based on the training, a guidance corpus for assisting users when performing the plurality of actions.

15. The system of claim 14, wherein the method performed by the processor further comprises:
monitoring the real-time data to determine if the user has successfully completed the first action according to the guidance; and
in response to identifying that the user has successfully completed the first action according to the guidance, updating the guidance corpus with the generated guidance.

16. A computer program product comprising a computer-readable storage medium having program instructions embodied therewith, the program instructions executable by a processor to cause the processor to perform a method comprising:
receiving a set of actions that a user requires assistance performing;
identifying one or more Internet of Things (IoT) devices associated with the user;
analyzing real-time data from the one or more IoT devices to determine a contextual surrounding of the user;
determining, in response to the analyzing, that a first contextual surrounding matches a first action of the set of actions that the user requires assistance performing;
determining, based on analyzing a current state of the user from the real-time data, if the user is in an optimal state to receive guidance when performing the first action;
generating, in response to the user being in the optimal state, guidance for assisting the user to perform the first action; and
providing the guidance to the user via the one or more IoT devices.

17. The computer program product of claim 16, wherein the one or more IoT devices is at least one of an augmented reality device, a virtual reality device, or a wearable smart device.

18. The computer program product of claim 16, wherein the guidance is provided to the user as a visual simulation on the one or more IoT devices.

19. The computer program product of claim 16, wherein the one or more IoT devices is at least one of a virtual reality device or an augmented reality device, and wherein providing the guidance to the user comprises displaying a gamified version of the guidance to the user.

20. The computer program product of claim 16, wherein the set of actions that a user requires assistance performing is chosen from a group of actions consisting of:
a speed measurement of one or more objects within the contextual surrounding of the user;
a speed measurement of the user with respect to one or more objects within the contextual surround of the user;
a distance measurement between two or more objects within the contextual surrounding of the user;
a geographic measurement of an area within the contextual surrounding of the user;
an assessment of volumetric space for receiving one or more objects within the contextual surrounding of the user; and
a mapping of one or more object within the contextual surrounding of the user.
